(19) United States
(12) Patent Application Publication
(10) Pub. No.: US 2015/0119036 A1
(43) Pub. Date: Apr. 30, 2015

(54) CELLULAR HANDOVER EXECUTION AFTER FIRST NON-BLIND HANDOVER FAILURE

(71) Applicant: QUALCOMM Incorporated, San Diego, CA (US)

(72) Inventors: Ming YANG, San Diego, CA (US); Tom CHIN, San Diego, CA (US); Qingxin CHEN, Del Mar, CA (US)

(73) Assignee: QUALCOMM Incorporated, San Diego, CA (US)

(21) Appl. No.: 14/067,647

(22) Filed: Oct. 30, 2013

(51) Int. Cl. H04W 36/00

(52) U.S. Cl. CPC H04W 36/0094; H04W 36/0016
USPC 455/436

(57) ABSTRACT

A user equipment (UE) may adjust a time permitted for a UE to attempt blind handover after a first non-blind handover failure to efficiently establish connection with a second radio access technology (RAT) or re-establish connection with a first RAT to increase handover success rate. In some instances, the UE may dynamically adjust the time permitted for acquiring a target RAT cell based on a signal strength of a target cell of the target RAT and/or a signal strength of a serving cell of a serving RAT, after a synchronized handover failed.

### TECHNICAL FIELD

Aspects of the present disclosure relate generally to wireless communication systems, and more particularly, to handover execution after a first non-blind handover failure.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes dynamically adjusting a time permitted for acquiring a target radio access technology (RAT) cell. The adjustment is based on a signal strength of a target cell of the target RAT and/or a signal strength of a serving cell of a serving RAT, after a synchronized handover failed.

According to another aspect of the present disclosure, an apparatus for wireless communication includes means for dynamically adjusting a time permitted for acquiring a target radio access technology (RAT) cell. The adjustment is based on a signal strength of a target cell of the target RAT and/or a signal strength of a serving cell of a serving RAT, after a synchronized handover failed. The apparatus may also include means for synchronizing to the target RAT during the dynamically adjusted time.

According to one aspect of the present disclosure, a computer program product for wireless communication in a wireless network includes a computer readable medium having non-transitory program code recorded thereon. The program code includes program code to dynamically adjust a time permitted for acquiring a target radio access technology (RAT) cell. The adjustment is based on a signal strength of a target cell of the target RAT and/or a signal strength of a serving cell of a serving RAT, after a synchronized handover failed.

According to one aspect of the present disclosure, an apparatus for wireless communication includes a memory and a processor(s) coupled to the memory. The processor(s) is configured to dynamically adjust a time permitted for acquiring a target radio access technology (RAT) cell. The adjustment is based on a signal strength of a target cell of the target RAT and/or a signal strength of a serving cell of a serving RAT, after a synchronized handover failed.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5A and 5B are call flow diagrams of a handover procedure according to aspects of the present disclosure.

FIG. 6 is a block diagram illustrating a wireless communication method for adjusting a time permitted for acquiring a target radio access technology (RAT) according to aspects of the present disclosure.

FIG. 7 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

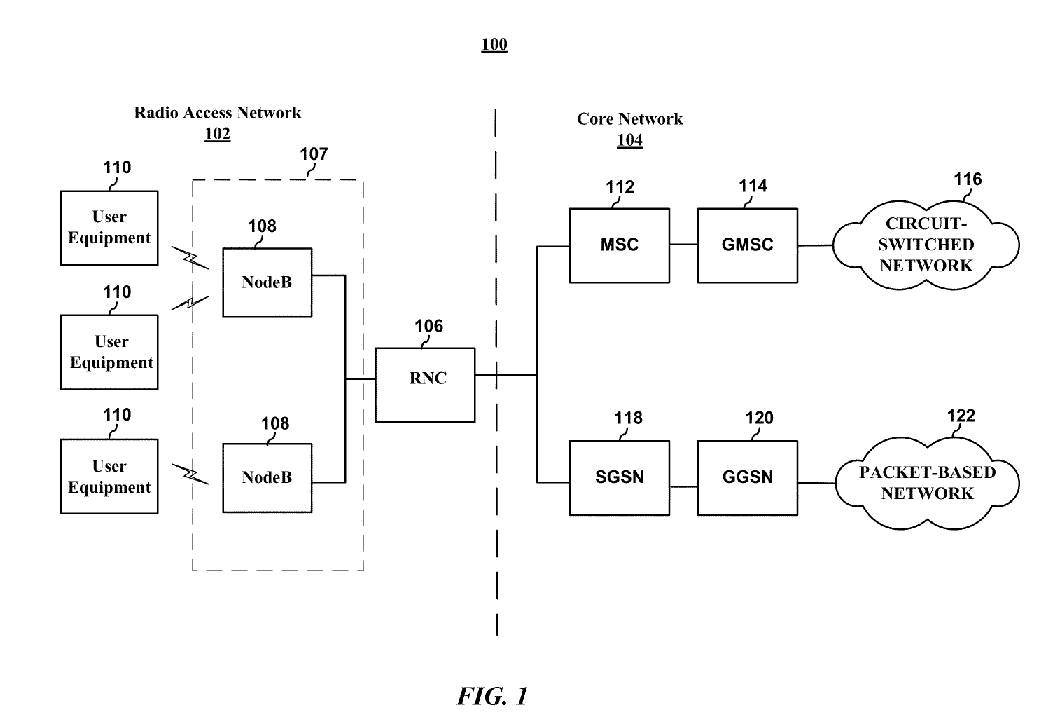

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General packet radio service (GPRS) is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

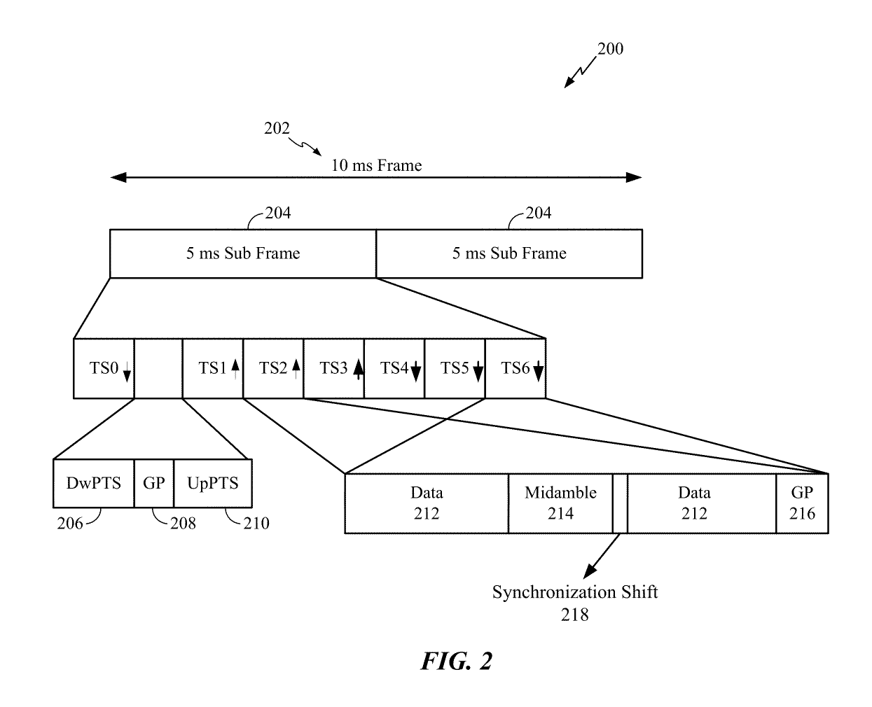

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

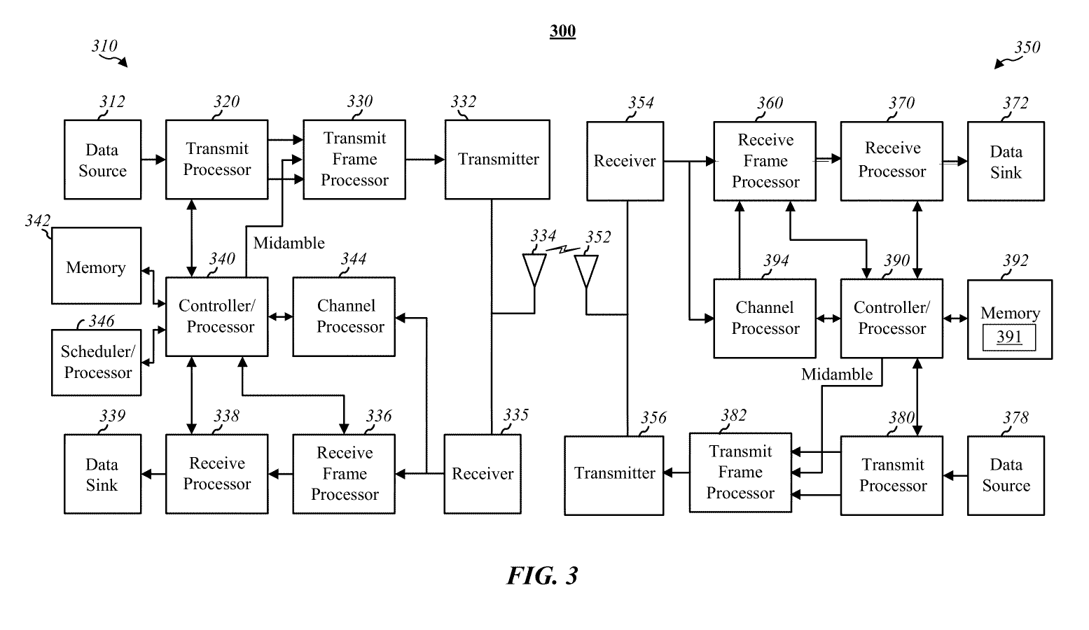

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a synchronizing module 391 which, when executed by the controller/processor 390, configures the UE 350 to dynamically adjust a time permitted for acquiring a target radio access technology (RAT) cell. The adjustment may be based on a signal strength of a target cell of the target RAT and/or a signal strength of a serving cell of a serving RAT, after a synchronized handover failed. A scheduler/processor 346 at the node B 310 may be used to allocate resources to the UEs and schedule downlink and/or uplink transmissions for the UEs.

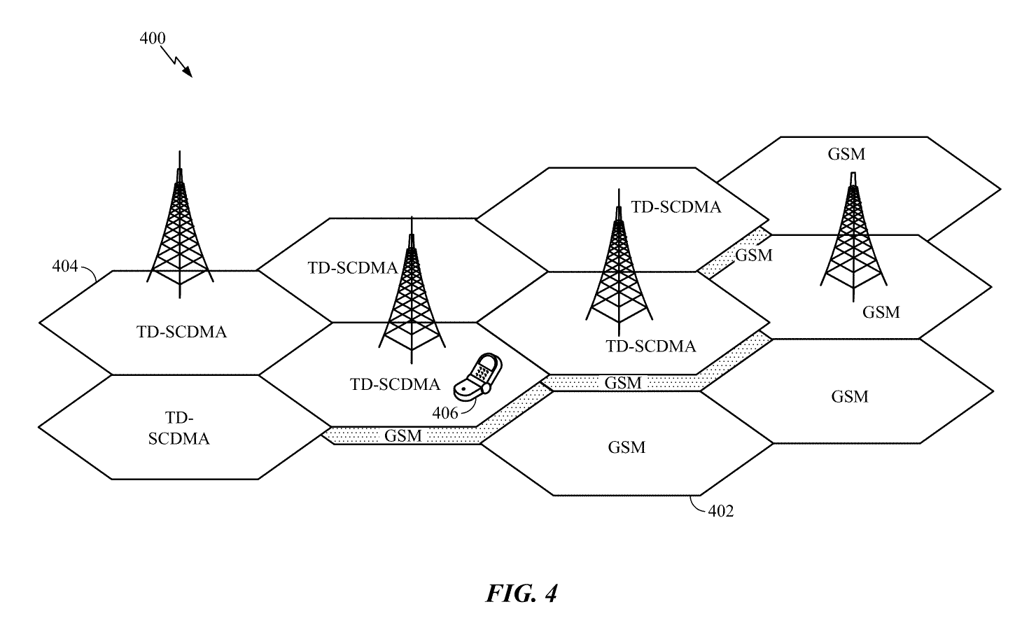

FIG. 4 illustrates coverage of a newly deployed network, such as a TD-SCDMA network and also coverage of a more established network, such as a GSM network. A geographical area 400 may include GSM cells 412 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

Handover Execution after First Non-Blind Handover Failure

Aspects of the present disclosure enable a user equipment (UE) to efficiently handover from a first radio access technology (RAT) to a second RAT or to efficiently establish connection with the second RAT or re-establish connection with the first RAT. To achieve this, the time period for the UE to attempt blind handover may be adjusted. For example, the time period may be adjusted to allow the UE to spend more or less time to synchronize to the second RAT after an initial (non-blind) handover failure.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a primary common control physical channel (P-CCPCH) or a primary common control physical shared channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of the broadcast control channel (BCCH) carrier, identifies the BSIC, at least one time, with an initial BSIC identification and reconfirms. The initial BSIC identification is performed within a predefined time period (for example, Tidentify_abort=5 seconds). The BSIC is re-confirmed at least once every Tre-confirm_abort seconds (e.g., Tre-confirm_abort=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

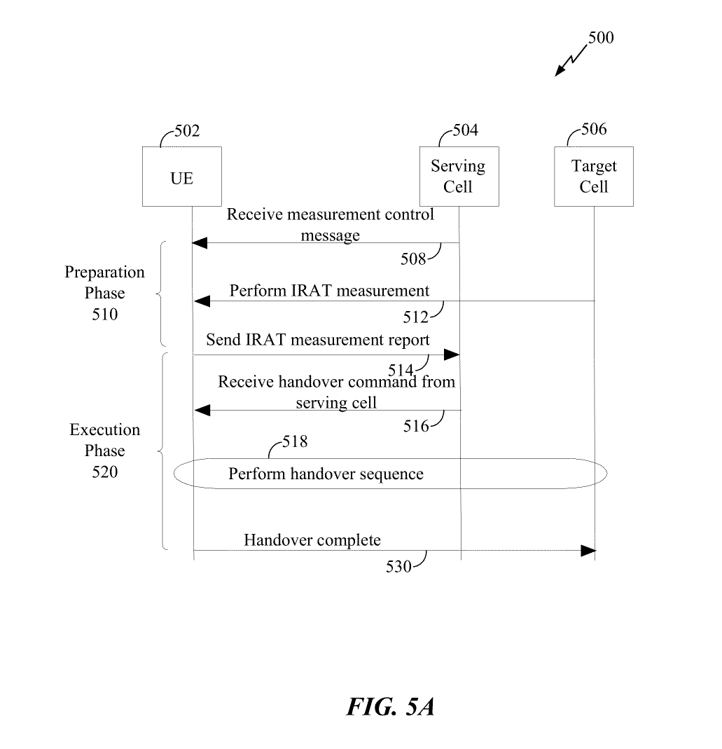

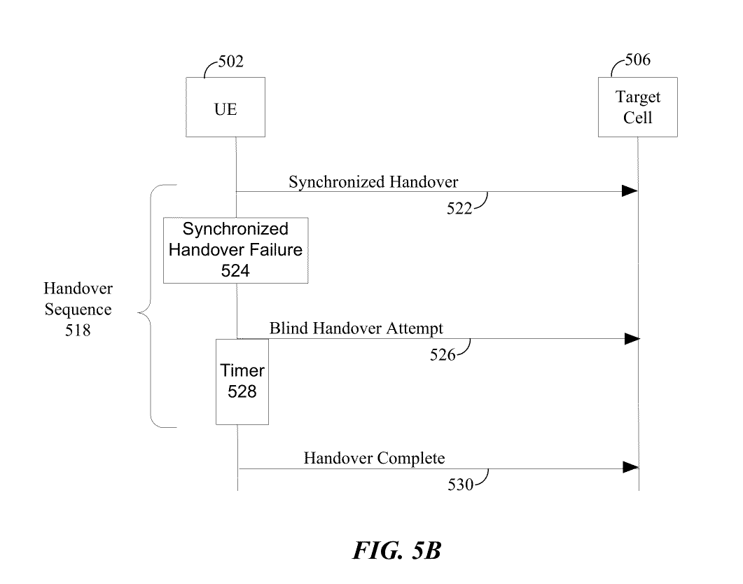

Handover of the UE from a serving cell to a target cell may be based on a series of handover operations between the UE, the serving cell (e.g., UTRAN), and the target cell (e.g., GERAN). Exemplary handover operations are illustrated by the call flow diagram of FIG. 5.

FIGS. 5A and 5B illustrate call flows of a handover of a UE 502 from a serving cell 504 to a target cell 506. In particular, in FIG. 5A, in the call flow 500, the IRAT handover to a target cell 506 may be achieved in a two phase process, including a preparation phase 510 and an execution phase 520. The preparation phase 510 may correspond to handover operations up to and including sending an IRAT measurement report, at time 514, by the UE 502. The IRAT measurement report may be sent in response to receiving a control message (e.g., measurement control message), at time 508, from the serving cell 504. The measurement control message (MCM) may identify neighbor cells (e.g., GSM neighbor cells) and IRAT measurement report triggering conditions of the neighbor cells to trigger the IRAT measurement report. The identified neighbor cells, including the target cell 506, may be included in a neighbor list associated with the control message.

The UE 502 performs the IRAT measurements of the neighbor cells, at time 512, in response to receiving the measurement control message. The UE 502 sends the result of the measurements in an IRAT measurement report to the serving cell 504, at time 514. The IRAT measurement report includes a list of the neighbor cells that meet the IRAT measurement report triggering conditions. The IRAT measurement report triggering conditions may correspond to a measurement threshold, such as a signal strength threshold. For example, the IRAT measurement report may include a list of the GSM neighbor cells that meet the signal strength threshold.

The execution phase 520 corresponds to handover operations after the UE 502 sends the IRAT measurement report up to and including the completion of the handover of the UE 502 from the serving cell 504 to the target cell 506, at time 530. For example, the execution phase 520 includes receiving an IRAT handover command from the serving cell 504, at time 516, performing a handover sequence, at time 518, and completing the handover of the UE 502 from the serving cell 504 to the target cell 506, at time 530. The target cell 506 may be one of the neighbor cells in the IRAT measurement report that meets the IRAT measurement report (MR) triggering conditions.

According to current implementations, before handover from a first or serving RAT (e.g., TD-SCDMA) to a second or target RAT (e.g., GSM) at time 530, the UE may perform IRAT measurements. For example, the UE measures the signal strength and timing of the second RAT and performs a base station identity code (BSIC) confirm procedure. The UE may also perform a BSIC re-confirm procedure for the second RAT. The IRAT measurements are performed to achieve a synchronized or non-blind handover.

More details of the handover sequence 518 are illustrated in FIG. 5B. Initially a non-blind (i.e., synchronized) handover is attempted at time 522. In the non-blind handover, the UE knows or pre-decodes the timing of the second RAT/network before being handed over to the second RAT. In this case, the UE can immediately decode system information of the second RAT. Accordingly, the UE may start service on the second RAT based at least in part on the timing of the second RAT.

Handover procedures may suffer from handover attempt failure, as seen at time 524. In some instances, the handover attempt failure may result from a change in an acquired timing (e.g., pre-decoded timing) of the second RAT. The change in the timing of the second RAT may be due to high mobility of the UE. As a result of the change, an initial handover attempt based on the pre-decoded timing (i.e., non-blind) of the second RAT may result in the handover attempt failure. Such handover attempt failure may result in throughput loss and may detrimentally impact the perception of a user on a radio communications network.

When the initial handover attempt fails, conventional implementation allows for the UE to stay on the cell or site of the second RAT. Thus, the UE may stay on the cell of the second RAT to search (blindly) for the second RAT (e.g., timing of the second RAT) at time 526. The search may be specified for a fixed period of time (at time 528) which may be predefined. The blind handover attempt (or search) after the initial non-blind handover failure may be performed to avoid a dropped call or network interruption.

In some specifications, the predefined period of time is 800 milliseconds (ms). In this case, the UE attempts (blindly) to synchronize or re-synchronize with the second RAT for 800 ms before declaring that the handover attempt failed. The UE may then follow a handover failure procedure, including returning to the first RAT. For example, after the fixed period of time expires, the UE may attempt to re-establish connection with the first RAT to recover the call. The delay associated with the fixed period of time can be substantial depending on the demand for radio resources in the first RAT. Aspects of the present disclosure seek to avoid or reduce delay issues associated with reestablishing connection due to a failed handover attempt.

Aspects of the disclosure are directed to adjusting a time (528) permitted for a UE to attempt blind handover after a first non-blind handover failure. The time permitted may be adjusted to reduce latency during handover. In one aspect of the disclosure, the permitted time period to attempt blind handover after an initial non-blind handover failure may be increased or decreased based on other information.

In some aspects, the time period may be increased/decreased based on the strength of the second RAT (e.g., target GSM cell). For example, if the target GSM cell for handover has a strong signal strength represented by a measurement of RSSI, the UE may attempt the blind handover for an increased time period. This feature may be implemented between the time of the handover decision to the time of the handover, so long as the target GSM cell continues to be a strong cell. Thus, the stronger the target GSM cell, the longer the UE is allowed to attempt blind handover before declaring failure.

In some instances, however, when the UE starts the handover procedure to the strong target GSM cell, the UE may enter a subway causing the signal strength of the target GSM cell to be weakened. When the signal strength is weakened below a desirable value, the GSM cell is no longer a good candidate for handover. In this case, the time period for attempting blind handover to the GSM cell may be reduced.

In some aspects of the disclosure, the time period may be increased/decreased based on the strength of the first RAT (e.g., serving TD-SCDMA cell). For example, the weaker the serving TD-SCDMA cell, the longer (i.e., increased time period) the UE is allowed to attempt blind handover to a target cell. Otherwise, when the serving TD-SCDMA cell has strong signal to sustain service, the time period for blind handover may be reduced. The time period is reduced to allow the UE to quickly re-establish connection or resynchronize to the strong serving TD-SCDMA cell.

In some aspects, the time period may be adjusted based on a type of communication or service being provided. Example services include, circuit switched (CS) voice call that is better supported by GSM cells and packet switched calls that are better supported by TD-SCDMA cells. For example, if there is a circuit switched voice call, the time period for the UE to synchronize to the target GSM cell may be increased. Increasing the time period allows the UE to stay longer to acquire the target GSM cell for the voice call. However, if there is a packet switched call, the time period for blind handover to the target GSM cell may be reduced. Reducing the time period allows the UE to quickly resynchronize to the serving TD-SCDMA cell for the packet switched call.

In one aspect of the disclosure, the time period may be adjusted based on a network configured threshold for handover. The network configured threshold may be an IRAT measurement reporting trigger threshold setting. To trigger handover from the serving TD-SCDMA cell to the target GSM cell, the network may configure a handover trigger event. For example, the network may indicate that handover is triggered when the serving TD-SCDMA cell signal strength is below a serving cell threshold value (e.g., thresholdownsystem) and when the target GSM cell signal strength is above a target cell threshold value (thresholdothersystem). For example, the network may trigger the handover when the TD-SCDMA cell signal strength is below −85 dBm and when the GSM cell signal strength is above −75 dBm. The time period for attempting blind handover may be adjusted based on the two threshold values. For example, the lower the thresholdownsystem value (i.e., indicating a weak signal) and the higher the thresholdothersystem value (i.e., indicating a strong signal), the longer the UE attempts the blind handover to the second RAT after the initial non-blind handover failure.

Further, the time period may be adjusted based on a signal strength/quality comparison of the serving TD-SCDMA cell and the target GSM cell. In one aspect, the time period may be adjusted based on a difference between a minimal signal strength/quality and a UE measured signal strength/quality for each of the serving TD-SCDMA cell and the target GSM cell. For example, the larger the difference for the target GSM cell and the lesser the difference for the serving TD-SCDMA cell, the longer the UE attempts blind handover after the initial non-blind handover failure.

By adjusting the time period (528) for attempting blind handover after the initial non-blind handover failure, the latency of recovering from a failed handover is reduced. Moreover, the success rate of recovering from a failed handover is improved. Thus, user perception of a failed handover is less likely and throughput loss is reduced.

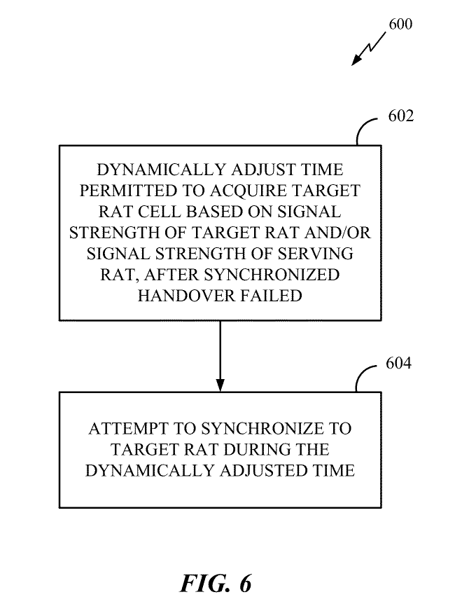

FIG. 6 is a block diagram illustrating a wireless communication method 600 for adjusting a time permitted for acquiring a target RAT according to aspects of the present disclosure. A UE may dynamically adjusts a time permitted for acquiring a target RAT cell, as shown in block 602. The dynamic adjustment is based on a signal strength of a target cell of the target RAT and/or a signal strength of a serving cell of a serving RAT. The adjustment may be performed after a synchronized handover failed. The UE attempts to synchronize to the target RAT during the dynamically adjusted time, as shown in block 604.

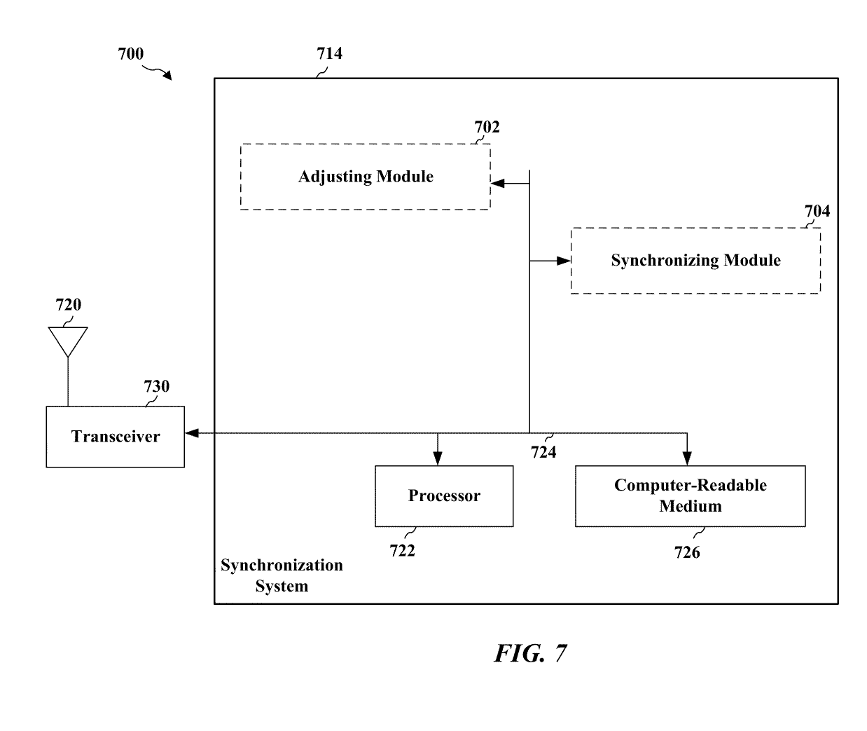

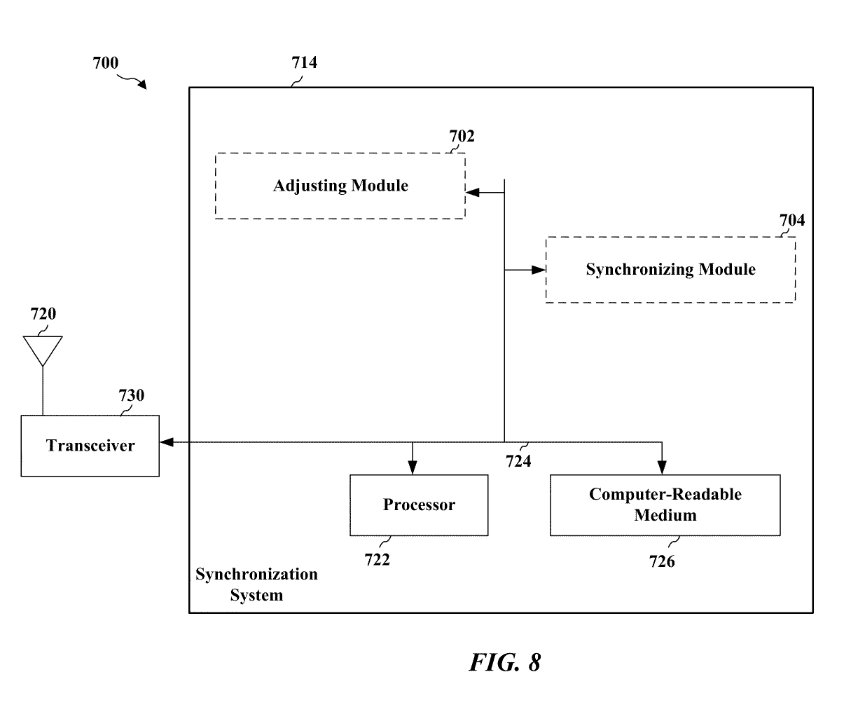

FIG. 7 is a diagram illustrating an example of a hardware implementation for an apparatus 700 employing a synchronization system 714. The synchronization system 714 may be implemented with a bus architecture, represented generally by the bus 724. The bus 724 may include any number of interconnecting buses and bridges depending on the specific application of the synchronization system 714 and the overall design constraints. The bus 724 links together various circuits including one or more processors and/or hardware modules, represented by the processor 722, the adjusting module 702, the synchronizing module 704, and the computer-readable medium 726. The bus 724 may also link various other circuits such as timing sources, peripherals, voltage regulators, and power management circuits, which are well known in the art, and therefore, will not be described any further.

The apparatus includes a synchronization system 714 coupled to a transceiver 730. The transceiver 730 is coupled to one or more antennas 720. The transceiver 730 enables communicating with various other apparatus over a transmission medium. The synchronization system 714 includes a processor 722 coupled to a computer-readable medium 726. The processor 722 is responsible for general processing, including the execution of software stored on the computer-readable medium 726. The software, when executed by the processor 722, causes the synchronization system 714 to perform the various functions described for any particular apparatus. The computer-readable medium 726 may also be used for storing data that is manipulated by the processor 722 when executing software.

The synchronization system 714 includes a adjusting module 702 for dynamically adjusting a time permitted for acquiring a target RAT cell. The synchronization system 714 also includes a synchronizing module 704 for attempting to synchronize to the target RAT during the dynamically adjusted time. The modules may be software modules running in the processor 722, resident/stored in the computer-readable medium 726, one or more hardware modules coupled to the processor 722, or some combination thereof. The synchronization system 714 may be a component of the UE 350 and may include the memory 392, and/or the controller/processor 390.

In one configuration, an apparatus, such as an UE 350, is configured for wireless communication including means for dynamically adjusting. In one aspect, the adjusting means may be the controller/processor 390, the memory 392, the synchronizing module 391, the adjusting module 702, the processor 722, and/or the synchronization system 714 configured to perform the functions recited by the aforementioned means. In another aspect, the aforementioned means may be a module or any apparatus configured to perform the functions recited by the aforementioned means.

In one configuration, the apparatus configured for wireless communication also includes means for synchronizing. In one aspect, the synchronizing means may be, the receive processor 370, the transmit processor 380, the controller/processor 390, the memory 392, the antenna 352, 720, the receiver 354, the transmitter 356, the transceiver 730, the synchronizing module 391, the synchronizing module 704, the processor 722, and/or the synchronization system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication during a handover, comprising:
dynamically adjusting a time permitted for acquiring a target radio access technology (RAT) cell based at least in part on a signal strength of a target cell of the target RAT and/or a signal strength of a serving cell of a serving RAT, after a synchronized handover failed, the adjusting initiated independent of a network.

2. The method of claim 1, in which the adjusting comprises increasing the time when the target cell is stronger.

3. The method of claim 1, in which the adjusting comprises decreasing the time when the serving cell is stronger.

4. The method of claim 1, further comprising adjusting based at least in part on a service type including at least one of a circuit switched service type and a packet switched service type, in which the circuit switched service type corresponds to a longer time when the target RAT comprises global system for mobile communications (GSM) and the packet switched service type corresponds to a shorter time when the serving RAT comprises time division-synchronous code division multiple access (TD-SCDMA).

5. The method of claim 1, further comprising adjusting based at least in part on a network configured target RAT threshold and/or serving RAT threshold for the handover.

6. The method of claim 5, in which a higher target RAT threshold corresponds to a longer time.

7. The method of claim 5, in which a higher serving RAT threshold corresponds to a shorter time.

8. The method of claim 1, in which the time permitted is adjusted for blindly acquiring the target RAT cell.

9. An apparatus for wireless communication during a handover, comprising:
means for dynamically adjusting a time permitted for acquiring a target radio access technology (RAT) cell based at least in part on a signal strength of a target cell of the target RAT and/or a signal strength of a serving cell of a serving RAT, after a synchronized handover failed the adjusting initiated independent of a network; and
means for synchronizing to the target RAT during the dynamically adjusted time.

10. The apparatus of claim 9, in which the adjusting means further comprises means for increasing the time when the target cell is stronger or means for decreasing the time when the serving cell is stronger.

11. An apparatus for wireless communication during a handover, comprising:
a memory; and
at least one processor coupled to the memory and configured:
to dynamically adjust a time permitted for acquiring a target radio access technology (RAT) cell based at least in part on a signal strength of a target cell of the target RAT and/or a signal strength of a serving cell of a serving RAT, after a synchronized handover failed, the adjusting initiated independent of a network.

12. The apparatus of claim 11, in which the at least one processor is further configured to adjust by increasing the time when the target cell is stronger.

13. The apparatus of claim 11, in which the at least one processor is further configured to adjust by decreasing the time when the serving cell is stronger.

14. The apparatus of claim 11, in which the at least one processor is further configured to adjust based at least in part on a service type including at least one of a circuit switched service type and a packet switched service type, in which the circuit switched service type corresponds to a longer time when the target RAT comprises global system for mobile communications (GSM) and the packet switched service type corresponds to a shorter time when the serving RAT comprises time division-synchronous code division multiple access (TD-SCDMA).

15. The apparatus of claim 11, in which the at least one processor is further configured to adjust based at least in part on a network configured target RAT threshold and/or serving RAT threshold for the handover.

16. The apparatus of claim 15, in which a higher target RAT threshold corresponds to a longer time.

17. The apparatus of claim 15, in which a higher serving RAT threshold corresponds to a shorter time.

18. The apparatus of claim 11, in which the time permitted is adjusted for blindly acquiring the target RAT.

19. An computer program product for wireless communications in a wireless network, comprising:
a non-transitory computer-readable medium having program code recorded thereon, the program code comprising:
program code to dynamically adjust a time permitted for acquiring a target radio access technology (RAT) cell based at least in part on a signal strength of a target cell of the target RAT and/or a signal strength of a serving cell of a serving RAT, after a synchronized handover failed, the adjusting initiated independent of a network.

20. The computer program product of claim 19, in which the program code to adjust further comprises program code to increase the time when the target cell is stronger or decrease the time when the serving cell is stronger.
